(19) United States
(12) Patent Application Publication
(10) Pub. No.: US 2017/0076235 A1
(43) Pub. Date: Mar. 16, 2017

(54) SYSTEM AND METHOD FOR SCHEDULING SOFTWARE UPDATES FOR INDUSTRIAL ASSETS BASED ON FORECASTED OPERATING DATA

(71) Applicant: General Electric Company, Schenectady, NY (US)

(72) Inventors: William Borea Noto, Niskayuna, NY (US); Paul Oliver Caffrey, Roanoke, VA (US); David Charles Korim, Albany, NY (US)

(21) Appl. No.: 14/854,155

(22) Filed: Sep. 15, 2015

(51) Int. Cl. G06Q 10/06; G06F 9/445

(52) U.S. Cl. CPC G06Q 10/06314; G06F 8/65

(57) ABSTRACT

A method for scheduling software updates for industrial assets may generally include receiving, with a computing device, an indication that a software update is available for an industrial asset, accessing, with the computing device, forecasted operating data for the industrial asset, determining, with the computing device, a suggested time for installing the software update based on the forecasted operating data and providing, with the computing device, a notification indicating the availability of the software update and the suggested time for installing the software update.

### FIELD OF THE INVENTION

The present subject matter relates generally to providing software updates for industrial assets and, more particularly, to a system and method for scheduling software updates for an industrial asset based on forecasted operating data.

### BACKGROUND OF THE INVENTION

A variety of approaches have been used to manage and update industrial assets, including approaches that manually update industrial assets using physical connections and/or components. System integrators and complex system owners must deploy and maintain industrial control systems for their industrial assets. Control systems typically include software, such as control code, diagnostics code, operating parameter sets and/or the like. Typically, industrial assets are controlled on a one-by-one basis in which individual assets are configured or managed separately from other assets.

In order to apply an update or upgrade to a control system for an industrial asset(s), an operator must typically approve the update prior to its installation. In addition, certain updates may require that an asset be taken offline or that specific conditions be met. As a result, scheduling the installation of an update for an asset control system is often quite challenging, particularly given that an improperly scheduled update can result in significant losses in the productivity and/or efficiency of the industrial asset and, thus, significant losses in the revenue generated and/or output derived from the asset.

Accordingly, an improved system and method for scheduling software updates for an industrial asset that addresses one or more of the problems identified in the prior art, such as losses in the productivity and/or efficiency of an asset, would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for scheduling software updates for industrial assets. The method may generally include receiving, with a computing device, an indication that a software update is available for an industrial asset, accessing, with the computing device, forecasted operating data for the industrial asset, determining, with the computing device, a suggested time for installing the software update based on the forecasted operating data and providing, with the computing device, a notification indicating the availability of the software update and the suggested time for installing the software update.

In another aspect, the present subject matter is directed to a method for scheduling software updates for wind turbines. The method may generally include receiving, with a computing device, an indication that a software update is available for a wind turbine, accessing, with the computing device, forecasted operating data for the wind turbine, determining, with the computing device, a suggested time for installing the software update based on the forecasted operating data and providing, with the computing device, a notification indicating the availability of the software update and the suggested time for installing the software update.

In a further aspect, the present subject matter is directed to a system for scheduling software updates for industrial assets. The system may generally include a computing device coupled to an industrial asset. The computing device may include at least one processor and associated memory. The memory may store instructions that, when implemented by the processor(s), configure the computing device to receive an indication that a software update is available for the industrial asset, access forecasted operating data for the industrial asset, determine a suggested time for installing the software update based on the forecasted operating data and provide a notification indicating the availability of the software update and the suggested time for installing the software update.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of one embodiment of a system for scheduling software updates for an industrial asset based on forecasted operating data in accordance with aspects of the present subject matter, particularly illustrating the system including an update server communicatively coupled to an asset controller over a network;

FIG. 2 illustrates another schematic view of an embodiment of the system shown in FIG. 1, particularly illustrating the update server communicatively coupled to a plurality of asset controllers disposed at various different locations;

FIG. 3 illustrates a flow diagram of one embodiment of a method for scheduling software updates for an industrial asset based on forecasted operating data in accordance with aspects of the present subject matter;

FIG. 4 illustrates a more detailed flow diagram of one example implementation of the method shown in FIG. 3;

FIG. 5 illustrates an example view of an industrial asset in accordance with aspects of the present subject matter, particularly illustrating a perspective view of one embodiment of a wind turbine; and

FIG. 6 illustrates a simplified view of one embodiment of a wind farm including a plurality of wind turbines, particularly illustrating the disclosed update server being communicatively coupled to a farm controller of the wind farm and/or a turbine controller associated with one or more of the wind turbines included within the wind farm.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for scheduling software updates for an industrial asset based on forecasted operating data associated with such asset. Specifically, in several embodiments, a new software update for an industrial asset(s) may be uploaded to or otherwise stored at an upgrade server located remote to the location of the industrial asset(s). In such embodiments, a local asset controller(s) configured to control the operation of the industrial asset(s) may be configured to communicate with the upgrade server to determine when the update is available for download. Upon downloading the software update, the asset controller(s) may be configured to analyze forecasted operating data associated with the industrial asset(s) to determine a suggested time in the future for installing the update. For instance, the asset controller(s) may suggest an installation time for the software update that, based on the forecasted operating data, is likely to minimize productivity and/or efficiency losses for the industrial asset. Thereafter, a notification may be provided to a manager/operator of the industrial asset(s) indicating that the software update is available to be installed. The notification may also provide the asset manager/operator with the suggested time for installing the update as determined by the asset controller(s) based on the forecasted data. The asset manager/operator may then decide whether the software update should be installed at the suggested time or at a different time. For instance, if the manager/operator determines that the time suggested by the asset controller(s) is not appropriate, the manager may request that the software update be installed prior to or following the suggested time, such as by requesting that the software update be installed immediately or by choosing that the installation of the update be delayed to a later time.

In a particular embodiment of the present subject matter, the asset controller(s) may correspond to a controller(s) (e.g., an individual turbine controller(s) and/or a farm controller(s)) configured to control the operation of one or more wind turbines located within a wind farm. In such an embodiment, when the asset controller(s) determines that a new software update is available for the wind turbine(s), the asset controller(s) may download the software update from the update server. Thereafter, the asset controller(s) may be configured to analyze forecasted operating data for the wind turbine(s) to determine a suggested time for installing the update. For instance, the asset controller(s) may be configured to analyze the forecasted weather conditions for the wind turbine(s) to determine a suggested time for installing the software update, such as by selecting a time that is forecasted for low wind conditions. The suggested time may then be transmitted to the manager/operator of the wind turbine farm to allow a decision to be made as to when the software update should actually be installed.

It should be appreciated that, as used herein, the term “industrial asset” or “asset” generally refers to any piece of industrial equipment that has a controller (e.g., a programmable logic controller) or other suitable computing device communicatively coupled thereto. Examples of assets include, but are not limited to, wind turbines, solar panels, gas turbines, water processing plants, aircraft engines, medical devices, and/or the like. Similarly, as used herein, the term “operating data” generally refers to any data associated with the operation of an industrial asset, such as measured and/or predicted operating parameters/conditions for the asset and/or the like. For instance, for industrial assets impacted by weather conditions (e.g., wind turbines and solar panels), operating data may include, but is not limited to, weather-related data, such as historical weather data and/or forecasted weather data. Similarly, operating data may include an operational status of an industrial asset, such as a speed value, a pressure value, a temperature value, a power output value and/or the like.

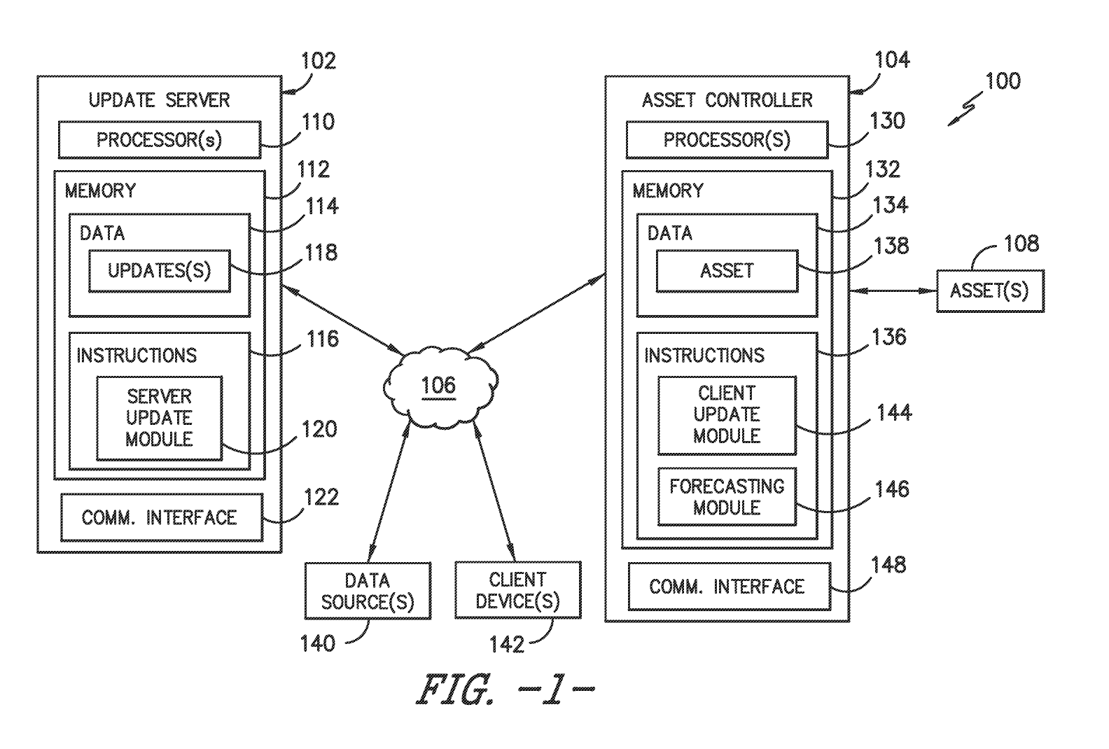

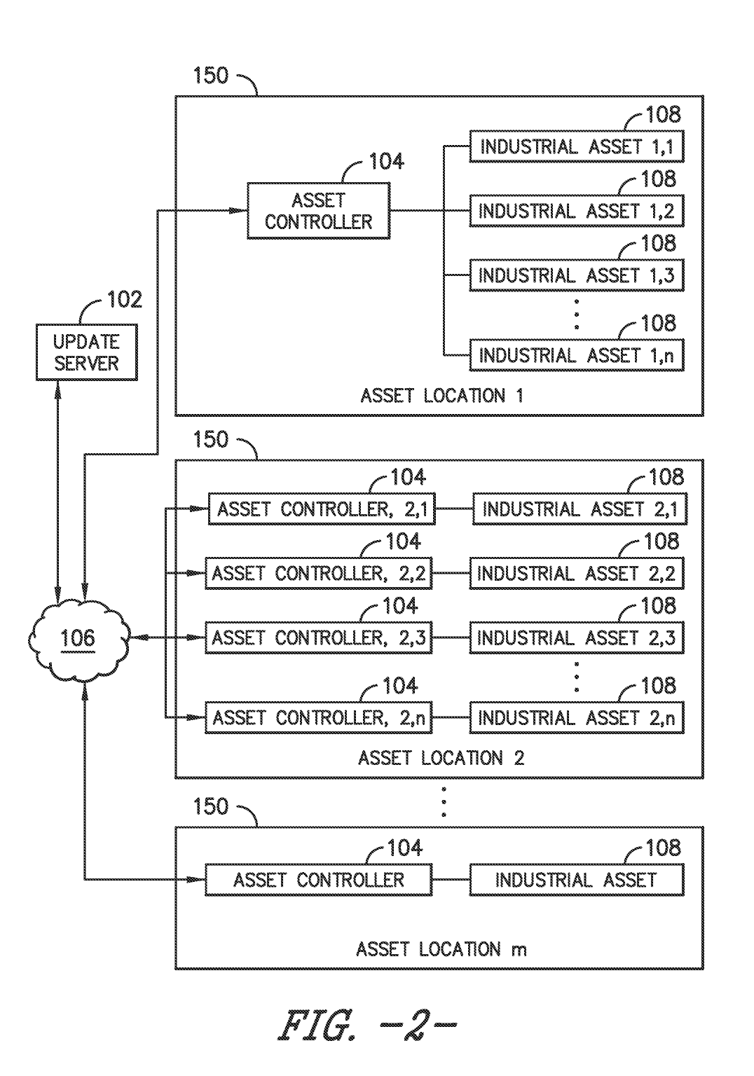

Referring now to FIG. 1, one embodiment of a system 100 for scheduling software updates for an industrial asset(s) based on forecasted operating data is illustrated in accordance with aspects of the present subject matter. As shown, the system 100 may include a client-server architecture, with a remote update server 102 being configure to communicate with one or more asset controllers 104 over a network 106. In general, the update server 102 may correspond to any suitable computing device and/or any suitable combination of computing devices. Similarly, the asset controller 104 may generally correspond to any suitable computing device (e.g., a programmable logic controller) and/or combination of computing devices configured to be coupled to and/or control one or more corresponding industrial assets 108. It should be appreciated that, although the upgrade server 102 is shown in FIG. 1 as being coupled to a single asset controller 104, the server 102 may generally be coupled to any number of asset controllers 104. For instance, as will be described below with reference to FIG. 2, the upgrade server 102 may be configured to provide software updates to a plurality of asset controllers 104 located at various different locations.

As shown in FIG. 1, the upgrade server 102 may generally include one or more processor(s) 110 and associated memory 112 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 112 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 112 may generally be configured to store information accessible to the processor(s) 110, including data 114 that can be retrieved, manipulated, created and/or stored by the processor(s) 110 and instructions 116 that can be executed by the processor(s) 110.

In several embodiments, the data 114 may be stored in one or more databases. For example, the memory 112 may include an update database 118 including data associated with one or more software updates to be provided to the asset controller 104. In such an embodiment, it should be appreciated that the software update(s) stored within the update database 118 may be generated by the update server 102 or may be received by the server 102 and subsequently stored within the update database 118. For instance, a software update for a given industrial asset 108 may be initially created/stored on a separate computing device and subsequently transmitted or uploaded to the update server 102 for storage thereon.

Additionally, in several embodiments, the instructions 116 stored within the memory 112 of the update server 102 may be executed by the processor(s) 110 to implement a server update module 120. In general, the update module 120 may provide a means for receiving, publishing and/or transmitting software updates to the asset controller 104 associated with each industrial asset 108. For instance, the update module 120 may be configured to receive a software update associated with a given industrial asset(s) 108 and subsequently communicate with the corresponding asset controller 104 regarding the availability of the update. Moreover, the update module 120 may also be configured to transmit or serve the software update to the asset controller 104.

As shown in FIG. 1, the update server 102 may also include a network or communications interface 122 to provide a means for the server 102 to communicate with the asset controller 104 or any other suitable computing device(s) over the network 106. In general, the communications interface 122 may correspond to any suitable device/medium that allows the server 102 to interface with the network 106 and/or any other suitable network.

Additionally, similar to the update server 102, the asset controller 104 may also include one or more processor(s) 130 and associated memory 132 configured to perform a variety of computer-implemented functions (e.g., performing the methods, steps, calculations and the like disclosed herein). Such memory 132 may generally be configured to store information accessible to the processor(s) 130, including data 134 that can be retrieved, manipulated, created and/or stored by the processor(s) 130 and instructions 136 that can be executed by the processor(s) 130.

In several embodiments, the data 134 may be stored in one or more databases. For instance, as shown in FIG. 1, the memory 132 may include an asset database 138 that stores data associated with the past, present and/or future operation of the industrial asset(s) 108 coupled to the asset controller 104. For example, in several embodiments, the asset database 138 may include historical data associated with the past operation of the industrial asset(s) 108 and/or forecasted data associated with the future operation of the industrial asset(s) 108. In addition, the asset database 138 may include data associated with one or more models or schedules related to the operation of the industrial asset(s) 108, such as a forecasting model configured to predict operating conditions/parameters associated with the future operation of the industrial asset(s) 108 and/or a maintenance or operation schedule associated with the industrial asset(s) 108. It should be appreciated that the data stored within the asset database 138 may be received directly from one or components associated with the industrial asset(s) 108 (e.g., sensors associated with the asset(s) 108) or may be received from one or more separate data sources 140. For instance, in one embodiment, operating data associated with forecasted weather conditions for an industrial asset(s) 108 may be received from a third-party weather forecasting service. Similarly, operating data associated with the maintenance and/or operating schedules for an industrial asset(s) may be received from a separate computing device, such as an authorized client device(s) 142 associated with the asset manager/operator.

Moreover, the instructions 136 stored within the memory 122 of the asset controller 104 may be executed by the processor(s) 130 to implement a client update module 144. In general, the client update module 144 may be configured to communicate with the server update module 120 for checking on the availability of new software updates and for downloading each software update(s) from the update server 102. For instance, the client update module 144 may be configured to periodically ping or poll the update server 120 to check for the availability of a new software update. When a new software update is available, the client update module 144 may then be configured to download the software update from the update server 102.

The instructions 136 stored within the memory 122 of the asset controller 104 may also be executed by the processor(s) 130 to implement a forecasting module 146. In general, the forecasting module 146 may be configured to analyze data associated with forecasted operating conditions for the industrial asset(s) 108 to determine a suggested time for installing a new software update received from the update server 102. For instance, as indicated above, the asset controller 104 may be configured to receive and/or store data associated with forecasted weather conditions for an industrial asset(s) 108. In such an embodiment, the forecasting module 146 may be configured to determine a suggested time for installing a new software update based on the forecasted weather conditions. For example, if the industrial asset(s) 108 corresponds to a wind turbine(s), the forecasting module 146 may suggest a time for installing the update when it is forecasted that the wind turbine(s) will be experiencing low wind conditions and/or other weather-related operating conditions that typically result in reduced power output. Similarly, as indicated above, the asset controller 104 may also receive and/or store data related to the operating schedule and/or the maintenance schedule for the industrial asset(s) 108. In such an embodiment, the forecasting module 146 may be configured to determine a suggested time for installing the software update that corresponds to the expected time at which the asset(s) 108 is scheduled to be down (e.g., for maintenance) or to be operating on a part-time or limited basis based on the referenced schedule(s). Moreover, the forecasting module 146 may also be configured to determine a suggested time for installing a new software update based on a forecasting model provided or developed for the industrial asset(s) 108. For example, a mathematical model may be developed based on historical operating data for the industrial asset(s) 108 that allows the forecasting module 146 to forecast or predict an appropriate time for installing the update that minimizes any losses associated with the asset's productivity and/or efficiency.

Moreover, the asset controller 104 may also include a network or communications interface 148 for communicating with the update server 102 or any other suitable computing device(s), such as the data source(s) 140 and/or the authorized client device(s) 142, over the network 106 (and/or any other suitable network). Similar to the interface 122 provided for the update server 102, the communications interface 148 may generally be any device/medium that allows the asset controller 104 to interface with the network 106.

It should be appreciated that the network 106 may correspond to any suitable wired or wireless network(s) that allows the various system components to communicate with one another via any suitable communications protocol (e.g. TCP/IP, HTTP, SMTP, FTP) and/or using any suitable encodings/formats (e.g. HTML, JSON XML) and/or protection schemes (e.g. VPN, secure HTTP, SSL). For example, in one embodiment, the network 106 may correspond to a wide-area network (WAN).

As indicate above, the asset controller 104 may be configured to notify a manager/operator of the industrial asset(s) 108 regarding the availability of each software update and the suggested time for installing such update. In one embodiment, the notifications may be generated by the asset controller 104 and subsequently displayed to the manager/operator via a display device associated with or coupled to the asset controller 104. In such an embodiment, the asset manager/operator may then utilize a user interface presented on the display device to schedule the installation of the software update, such as by instructing the asset controller 104 to install the software update at the suggested time or at a different time selected by the manager/operator. Alternatively, the asset controller 104 may be configured to transmit the notifications to a separate computing device(s), such as an authorized client device(s) 142 of the asset manager/operator. For instance, the asset controller 104 may be configured to store a list of each client device 142 that is authorized to receive notifications regarding the availability of software updates for the particularly industrial asset(s) 108 coupled to such controller 104. Thus, when a software update is available, the asset controller 104 may transmit a notification(s) directly to the authorized client device(s) 142. The asset manager/operator may then use his/her client device 142 to schedule the installation of the software update, such as by using a suitable user interface on his/her device to instruct the asset controller 104 to install the software update at the suggested time or at a different time selected by the manager/operator.

It should be appreciated that, in the event that the manager/operator selects a time that differs from the time suggested by the asset controller 104, the manager/operator may, in certain embodiments, be presented (e.g., via the user interface) with an estimate regarding the impact that installing the update at the selected time may have on the productivity and/or efficiency of the associated industrial asset(s) as compared to installing the update at the suggested time. For instance, the manager/operator may be presented with an “operations loss calculation” that indicates the productivity losses and/or efficiency losses that may occur if the update is installed at the manager/operator-selected time as opposed to the suggested time. The manager/operator may then select to proceed with the installation at his/her originally selected time or may select a different time for installing the update (e.g., by going back and selecting the time suggested by the asset controller 104 or by selecting a completely different time).

It should also be appreciated that each client device 142 may generally correspond to any suitable computing device and/or combination of computing devices, such as any suitable display(s) having one or more processors coupled thereto and/or embedded therein. However, in a particular embodiment, each client device 142 may correspond to a mobile device, such as a smartphone, a tablet, a wearable computing device(s) and/or any other suitable portable device(s).

Additionally, it should be appreciated that, although various functions and/or processes are generally described above as being performed by a given system component (e.g., the update server 102 and/or the asset controller 104), such functions and/or processes may, instead, by performed by a different system component. For example, as opposed to the asset controller 104, the update server 102 may be configured to transmit notifications to the asset manager/operator regarding the availability of a software update and/or the suggested time for installing the update. In addition, the update server 102 may also be configured to analyze the forecasted operating data for the industrial asset(s) in order to determine the suggested time for installing the update.

Moreover, as indicated above, it should be appreciated that the update server 102 may be configured to communicate with various different asset controllers 104 located at any number of remote locations, with each asset controller 104 being configured to be coupled to and/or control the operation of one or more industrial assets 108. For instance, as shown in the embodiment of FIG. 2, the system 100 may be implemented across a plurality of different asset locations 150 (e.g., locations 1, 2, . . . m). In such an embodiment, each location 150 may include one or more industrial assets 108 coupled to and/or controlled by one or more corresponding asset controllers 104, with each asset controller 104 being communicatively coupled to the update server 102 via the network 106. As such, the update server 102 may be configured to distribute the same or different software upgrades to various remote locations 150.

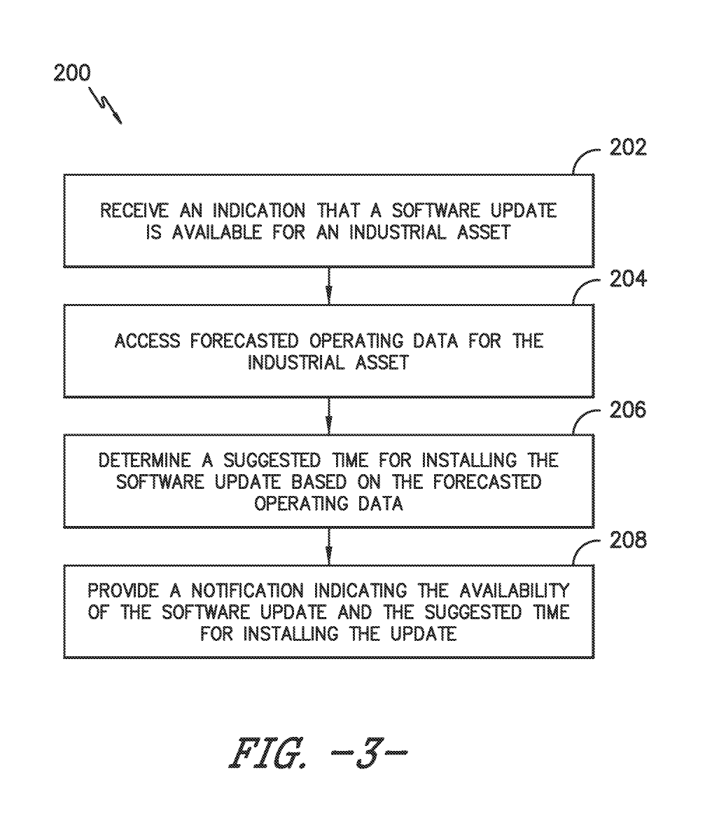

Referring now to FIG. 3, a flow diagram of one embodiment of a method 200 for scheduling software updates for industrial assets is illustrated in accordance with aspects of the present subject matter. In general, the method 200 will be described herein with reference to the system 100 described above with reference to FIGS. 1 and 2. However, it should be appreciated that the disclosed method 200 may also be utilized with any other suitable system to allow for the scheduling of software updates for industrial assets. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 3, at (202), the method 200 may include receiving an indication that a software update is available for an industrial asset. For instance, as indicated above, the asset controller 104 may be configured to communicate with the update server 102 regarding the availability of a new software update. In such instance, when a new software update is available at the update server 102, the server 102 may transmit an indication of the availability of the update to the asset controller 104. Upon receiving the indication, the asset controller 104 may download the software update from the update server 102.

Additionally, at (204), the method 200 may include accessing forecasted operating data for the industrial asset. For instance, as indicated above, the asset controller 104 may be configured to access forecasted operating data for the industrial asset(s) 108 coupled to such controller 104. The forecasted operating data may, for example, correspond to any suitable data relating to or otherwise associated with the future operation of the industrial asset, such as forecasted weather conditions, maintenance schedules, operation schedules, forecasting models and/or the like. As indicated above, the forecasted operating data may correspond to and/or derive from data stored within the memory 132 of the asset controller 104. Alternatively, the forecasted operating data may correspond to or derive from data received from a separate computing device, such as a separate data source 140 and/or a separate client device 142.

Moreover, at (206), the method 200 may include determining a suggested time for installing the software update based on the forecasted operating data. Specifically, in several embodiments, the asset controller 104 may be configured to analyze the forecasted operating data to determine the suggested time for installing the update. For instance, the forecasted operating data may be analyzed to identify one or more times occurring in the future at which the software update may be installed while minimizing the impact to the productivity and/or efficiency of the industrial asset, such as by identifying a time(s) at which a wind turbine is forecasted to be experiencing low wind conditions. The asset controller 104 may then select a suggested time for installing the software update based on the analysis of the forecasted data.

Referring still to FIG. 3, at (208), the method 200 may include providing a notification indicating the availability of the software update and the suggested time for installing the software update. Specifically, in several embodiments, the asset controller 104 may be configured to provide a notification to a manager/operator of the industrial asset 108 regarding the availability of the software update and the suggested time for installing the software update. As indicated above, such notification may be provided to the manager/operator by displaying the notification on a display device coupled to or associated with the asset controller 104. Alternatively, the notification may be transmitted by the asset controller 104 to a separate computing device, such as an authorized client device 142 associated with the asset manager/operator.

Upon receiving the notification, the asset manager/operator may then provide a suitable input to the asset controller 104 (e.g., directly via an input device associated with the asset controller 104 or indirectly via a separate computing device, such as his/her client device 142) associated with a selected time for installing the software update. For instance, as indicated above, the asset manager/operator may utilize a suitable user interface to provide a user input associated with selecting the desired time for installing the software update. In such instance, the selected time may correspond to the time suggested by the asset controller 104. Alternatively, the selected time may correspond to a time that differs from the suggested time, such as a time occurring before or after the suggested time. Regardless, once the input from the asset manager/operator is received, the asset controller 104 may be configured to install the software update at the selected time.

It should be appreciated that, in one embodiment, the notification transmitted to the manager/operator may indicate whether the time suggested by the asset controller 104 corresponds to an “opt-in” event or an “opt-out” event. For instance, for an “opt-in” event, the notification may indicate that the manager/operator must provide an input selecting or confirming a time for installing the update prior to such update being installed (e.g., “The suggested installation time for the update is on [date] at [time]. Please click to confirm installation for the suggested date/time or choose another installation time.”). Similarly, for an “opt-out” event, the notification may indicate that the update will be installed at the suggested time unless the manager/operator provides an input cancelling or rescheduling the update (e.g., “The suggested installation time for the update is on [date] at [time]. The update will be installed at the suggested date/time unless you cancel or reschedule the installation.”).

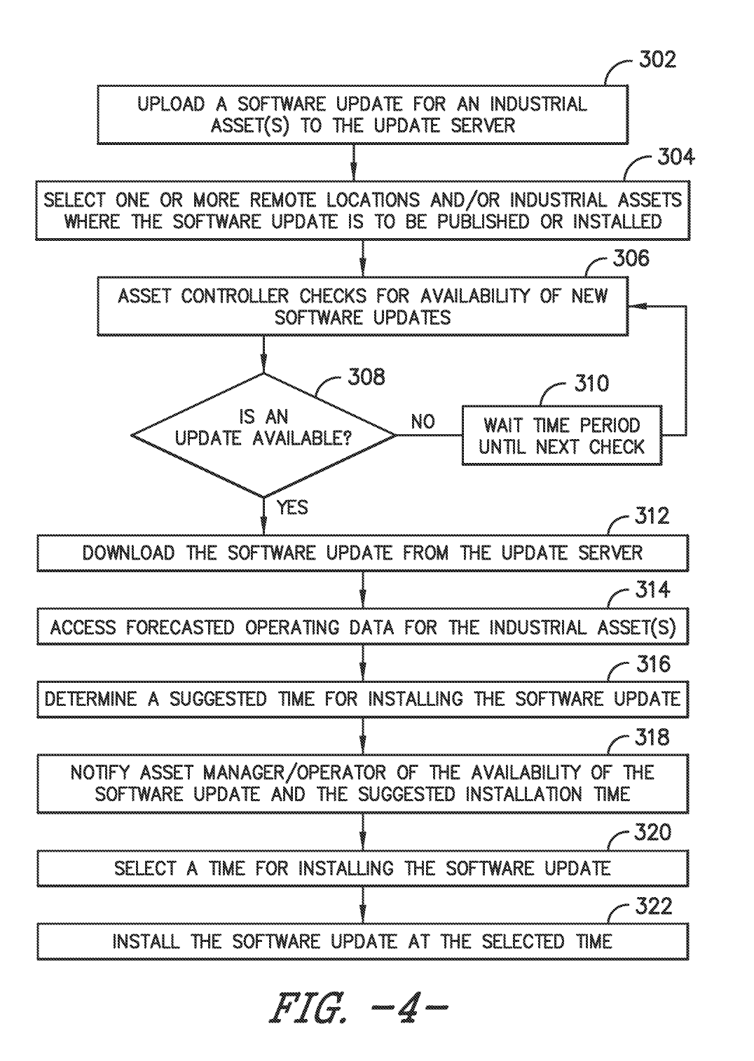

Referring now to FIG. 4, a more detailed flow diagram of one example implementation of the method 200 described above with reference to FIG. 3 is illustrated in accordance with aspects of the present subject matter. As shown, at (302), an engineer, manager, operator, or other user may upload a software update for an industrial asset(s) 108 to the update server 102 (e.g., by uploading a new instance of control code, a new parameter set and/or a new instance of diagnostics code for the industrial asset(s) 108). Additionally, at (304), the user may select one or more remote locations 150 and/or one or more industrial assets 108 located at such remote location(s) 150 where the new software update is to be published or installed.

Moreover, at (306), an asset controller 104 located remote to the update server 102 may check to see if any new software updates are available for the asset(s) 108 coupled to such controller 104. For instance, as indicated above, the asset controller 104 may be configured to periodically poll the update server 102 for new updates. Alternatively, the update server 102 may be configured to transmit an indication of the availability of a new software update to the asset controller 104 without any periodic polling by the asset controller 104. As shown in FIG. 4, the process flow may vary, at (308), depending on whether a new software update is available. Specifically, if a software update is not available, the asset controller 104 may, at (310) wait a predetermined time period prior to checking again for the availability of a new software update. However, if a software update is available, the asset controller 104 may, at (312) download the update from the update server 102.

Additionally, as shown in FIG. 4, at (314), the asset controller 104 may access forecasted operating data for the industrial asset(s) 108. Based on the forecasted operating data, the asset controller 104 may then, at (316) determine a suggested time for installing the software update. Thereafter, at (318), the asset controller 104 may notify a manager/operator of the industrial asset(s) 108 regarding the availability of the software update and the suggested time for installing the update. For instance, as indicate above, the asset controller 104 may provide the notification for display to the manager/operator on a display device coupled to or associated with the controller 104. Alternatively, the asset controller 104 may transmit the notification to a separate computing device, such as an authorized client device 142 of the manager/operator.

Moreover, at (320), based on the notification receive from the asset controller 104, the asset manager/operator may select an appropriate time for installing the software update. For instance, as indicated above, the asset manager/operator may be provided with a user interface that allows the manager/operator to select an installation time for the upgrade, such as by allowing the manager/operator to select the suggested installation time or a time that differs from the suggested time. The user input provided by the asset manager/operator may then be transmitted to or otherwise received by the asset controller 104. Thereafter, at (322), the asset controller 104 may install the software update at the time selected by the asset manager/operator.

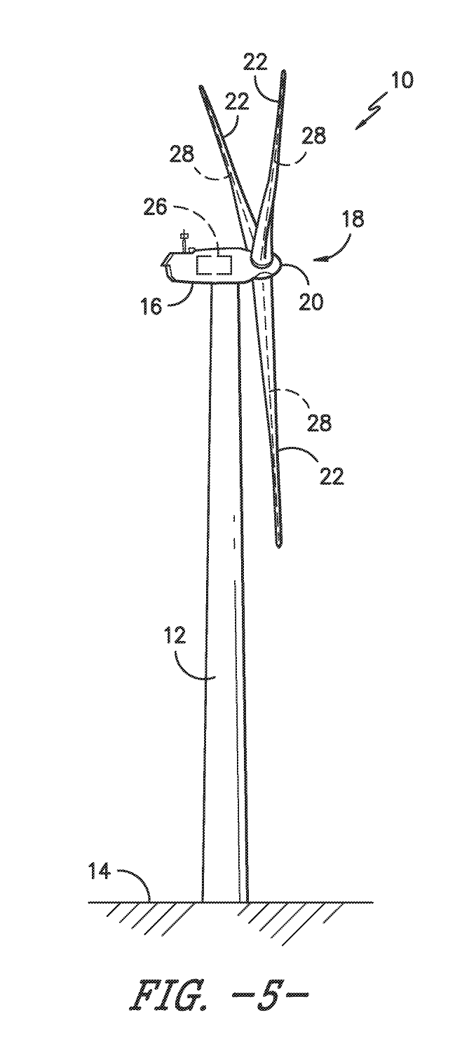

As indicated above, each industrial asset 108 described herein may generally correspond to any piece of industrial equipment that has a controller or other suitable computing device communicatively coupled thereto. However, in a particular embodiment, each industrial asset 108 may correspond to a wind turbine. In this regard, FIG. 5 illustrates a perspective view of one embodiment of a wind turbine 10 suitable for use within the disclosed system 100 in accordance with aspects of the present subject matter.

As shown in FIG. 5, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

The wind turbine 10 may also include a turbine control system or turbine controller 26 centralized within the nacelle 16 (or disposed at any other suitable location within and/or relative to the wind turbine 10). In general, the turbine controller 26 may comprise a computing device or other suitable processing unit. Thus, in several embodiments, the turbine controller 26 may include suitable computer-readable instructions that, when implemented, configure the controller 26 to perform various different functions, such as receiving, transmitting and/or executing wind turbine control signals. As such, the turbine controller 26 may generally be configured to control the various operating modes (e.g., start-up or shut-down sequences) and/or components of the wind turbine 10. For example, the controller 26 may be configured to adjust the blade pitch or pitch angle of each rotor blade 22 (i.e., an angle that determines a perspective of the blade 22 with respect to the direction of the wind) about its pitch axis 28 in order to control the rotational speed of the rotor blade 22 and/or the power output generated by the wind turbine 10. For instance, the turbine controller 26 may control the pitch angle of the rotor blades 22, either individually or simultaneously, by transmitting suitable control signals to one or more pitch drives or pitch adjustment mechanisms (not shown) of the wind turbine 10.

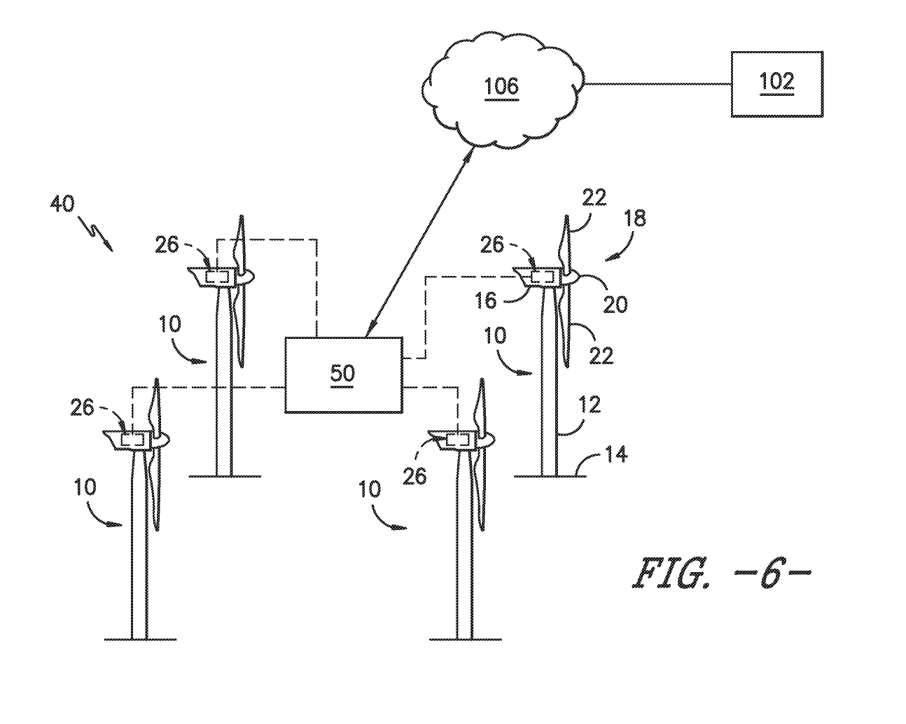

It should be appreciated that, in several embodiments, the wind turbine 10 shown in FIG. 5 may correspond to one of a plurality of wind turbines 10 located within a wind farm 40. For example, FIG. 6 illustrates a simplified view of a wind farm 40 including a plurality of wind turbines 10. For purposes of illustration, the wind farm 40 is simply shown as including four wind turbines 10. However, it should be readily appreciated by those of ordinary skill in the art that the wind farm 40 may include any other number of wind turbines 10, such as greater than four wind turbines 10 or even less than four wind turbines 10. For instance, it is common for wind farms 40 to include fifty or more wind turbines 10 or even one hundred or more wind turbines 10.

It should also be appreciated that each wind turbine 10 located within the wind farm 40 may generally be configured the same as or similar to the wind turbine 10 described above with reference to FIG. 5. For example, each wind turbine 10 may include a tower 12 extending from a support surface 14, a nacelle 16 mounted on the tower 12, and a rotor 18 coupled to the nacelle 16, with the rotor 18 comprising a rotatable hub 20 and one or more rotor blades 22. Additionally, each wind turbine 10 may include a turbine controller 26 configured to monitor the turbine's operating parameters and/or control the operation of the wind turbine 10.

Additionally, as shown in FIG. 6, the wind farm 40 may also include a farm controller 50 communicatively coupled to each wind turbine 10, such as by being communicatively coupled to each turbine controller 26. Similar to each turbine controller 26, the farm controller 50 may generally comprise a computing device and/or any other suitable processing unit. Thus, in several embodiments, the farm controller 50 may include suitable computer-readable instructions that, when implemented, configure the controller 50 to perform various different functions, such as issuing and/or transmitting wind turbine control signals to each turbine controller 26. As such, the farm controller 50 may generally be configured to control any or all of the turbine controllers 26 in the wind turbine farm 40 in order to change or alter the operating mode of any number of the wind turbines 10. Specifically, the farm controller 50 may be configured to command a single wind turbine 10, particular groups of wind turbines 10 or all of the wind turbines 10 in the wind turbine farm 40 to enter into a particular operating mode and/or to perform a particular action in order to adapt the wind turbine(s) 10 to changing operating conditions and/or to otherwise control the operation of the turbine(s) 10.

In accordance with aspects of the present subject matter, the asset controller 104 described above with reference to FIGS. 1-4 may correspond to the individual turbine controller 26 for each wind turbine 10 and/or the farm controller 50 for the wind turbine farm 40. In other embodiments, the asset controller 104 may correspond to any other suitable computing device(s) coupled to one or more of the turbine controllers 26 and/or the farm controller 50. In such an embodiment, the asset controller 104 may be configured to communicate with the update server 102 so as to to acquire software updates for each individual wind turbine 10 or for multiple wind turbines 10 included the wind farm 40 (e.g., via the network 106 shown in FIG. 6). In addition, the asset controller 104 may be configured to analyze the forecasted wind conditions for one or more of the wind turbines 10 so as to determine a suggested time for installing the software update receive from the update server 102. For instance, the suggested time may correspond to a time at which it is forecasted that the wind turbine(s) 10 will experience wind conditions below a predetermined threshold. Thereafter, similar to the embodiments described above, the asset controller 104 may be configured to transmit a notification to the manager/operator of each wind turbine 10 and/or of the wind farm 40 indicating that a new software update is available and providing the suggested time for installing the update. Moreover, once the manager/operator provides his/her input regarding the selected time for the installation, the asset controller 104 may be configured to install the software update for the corresponding wind turbine(s) 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for scheduling software updates for industrial assets, the method comprising:
receiving, with a computing device, an indication that a software update is available for an industrial asset;
accessing, with the computing device, forecasted operating data for the industrial asset;
determining, with the computing device, a suggested time for installing the software update based on the forecasted operating data; and
providing, with the computing device, a notification indicating the availability of the software update and the suggested time for installing the software update.

2. The method of claim 1, wherein receiving the indication that the software update is available comprises receiving the indication from a separate computing device located remote to the industrial asset.

3. The method of claim 2, further comprising downloading, with the computing device, the software update from the separate computing device upon receiving the indication that the software update is available.

4. The method of claim 1, wherein accessing the forecasted operating data for the industrial asset comprises retrieving the forecasted operating data from a data source separate from the computing device.

5. The method of claim 1, wherein accessing the forecasted operating data for the industrial asset comprises retrieving the forecasted operating data from memory of the computing device.

6. The method of claim 1, wherein the forecasted operating data corresponds to forecasted weather conditions for the industrial asset or a schedule associated with the operation of the industrial asset.

7. The method of claim 1, further comprising analyzing the forecasted operating data to determine the suggested time for installing the software update.

8. The method of claim 1, further comprising receiving an input associated with a selected time for installing the software update.

9. The method of claim 8, further comprising installing the software update at the selected time.

10. The method of claim 8, wherein the selected time corresponds to the suggested time or a time that differs from the suggested time.

11. The method of claim 1, wherein providing the notification comprises transmitting the notification to a client device associated with a manager or operator of the industrial asset, the client device being separate from the computing device.

12. A method for scheduling software updates for wind turbines, the method comprising:
receiving, with a computing device, an indication that a software update is available for a wind turbine;
accessing, with the computing device, forecasted operating data for the wind turbine;
determining, with the computing device, a suggested time for installing the software update based on the forecasted operating data; and
providing, with the computing device, a notification indicating the availability of the software update and the suggested time for installing the software update.

13. The method of claim 12, wherein the computing device corresponds to a turbine controller for the wind turbine or a farm controller for a wind turbine farm within which the wind turbine is located.

14. The method of claim 12, wherein the forecasted operating data corresponds to forecasted weather conditions for the wind turbine.

15. The method of claim 14, wherein determining the suggested time for installing the software update based on the forecasted operating data comprises selecting the suggested time based on the forecasted weather conditions such that the suggested time corresponds to a time at which it is forecasted that the wind turbine will experience wind conditions below a predetermined threshold.

16. A system for scheduling software updates for industrial assets, the system comprising:
a computing device coupled to an industrial asset, the computing device including at least one processor and associated memory, the memory storing instructions that, when implemented by the at least one processor, configure the computing device to:
receive an indication that a software update is available for the industrial asset;
access forecasted operating data for the industrial asset;
determine a suggested time for installing the software update based on the forecasted operating data; and
provide a notification indicating the availability of the software update and the suggested time for installing the software update.

17. The system of claim 16, wherein the computing device is further configured to analyze the forecasted operating data to determine the suggested time for installing the software update.

18. The system of claim 16, wherein the computing device is further configured to receive an input associated with a selected time for installing the software update.

19. The system of claim 18, wherein the computing device is further configured to install the software update at the selected time.

20. The system of claim 18, wherein the selected time corresponds to the suggested time or a time that differs from the suggested time.
